(19) United States
(12) Patent Application Publication
(10) Pub. No.: US 2025/0138852 A1
(43) Pub. Date: May 1, 2025

(54) TASK PROCESSING

(71) Applicant: Beijing Zitiao Network Technology Co., Ltd., Beijing (CN)

(72) Inventors: Rui Peng, Beijing (CN); Lele Chen, Beijing (CN)

(21) Appl. No.: 18/889,537

(22) Filed: Sep. 19, 2024

(30) Foreign Application Priority Data
Oct. 31, 2023 (CN) 202311437966.7

(51) Int. Cl. G06F 9/451

(52) U.S. Cl. CPC G06F 9/453

(57) ABSTRACT

According to embodiments of the disclosure, a method, apparatus, device and storage medium for task processing are provided. In the method, a target task to be executed at a target device is determined based on an interaction between a user and a digital assistant. The digital assistant runs on the target device. In response to determining that the target task is associated with a target application on the target device, the availability of the target application is determined. The availability indicates whether the digital assistant is permitted to execute the target task using the target application. Further, feedback information for the target task is determined based on the availability of the target application. In this way, the efficiency of the digital assistant in assisting users can be improved.

### CROSS-REFERENCE

The present application claims priority to Chinese Patent Application No. 202311437966.7, filed on Oct. 31, 2023, and entitled “METHOD, APPARATUS, DEVICE AND STORAGE MEDIUM FOR TASK PROCESSING”, the entirety of which is incorporated herein by reference.

### FIELD

Example embodiments of the present disclosure generally relate to the field of computers, and more particularly, to task processing.

### BACKGROUND

Digital assistants are provided to assist users in various types of task processing needs in different applications and scenarios. Digital assistants usually have intelligent dialogue and task processing capabilities. In the process of the interaction with digital assistants, users input interactive messages, and digital assistants respond to the user input to provide reply messages and/or handle tasks indicated by the users. Typically, digital assistants can support the input of a user's questions in natural language format and perform tasks and provide responses based on the digital assistant's understanding of the natural language input and logical reasoning ability. Such interaction methods have become tools that people love and rely on due to their flexible and convenient characteristics. In the interaction between the users and the digital assistants, it is expected that more and more improved solutions can be provided to process the tasks instructed by the users.

### SUMMARY

In a first aspect of the present disclosure, a method for task processing is provided. In the method, a target task to be executed at a target device is determined based on an interaction between a user and a digital assistant. The digital assistant runs on the target device. In response to determining that the target task is associated with a target application on the target device, the availability of the target application is determined. The availability indicates whether the digital assistant is permitted to execute the target task using the target application. Further, feedback information on the target task is determined based on the availability of the target application.

In a second aspect of the present disclosure, an apparatus for task processing is provided. The apparatus includes a task determination module, an availability determination module, and a feedback determination module. The task determination module is configured to determine a target task to be executed at the target device based on an interaction between a user and a digital assistant. The availability determination module is configured to determine the availability of the target application in response to determining that the target task is associated with a target application on the target device. The availability indicates whether the digital assistant is permitted to execute the target task using the target application. The feedback determination module is configured to determine feedback information for the target task based on the availability of the target application.

In a third aspect of the present disclosure, an electronic device is provided. The device includes at least one processing unit; and at least one memory coupled to the at least one processing unit and storing instructions for execution by the at least one processing unit. The instructions, when executed by the at least one processing unit, cause the apparatus to perform operations that implement the method of the first aspect.

In a fourth aspect of the present disclosure, a computer readable storage medium is provided. The computer readable storage medium stores a computer program, and the computer program is executable by a processor to perform operations that implement the method in the first aspect.

It would be appreciated that the content described in the section is neither intended to identify the key features or essential features of the present disclosure, nor is it intended to limit the scope of the present disclosure. Other features of the present disclosure will be readily understood through the following description.

### BRIEF DESCRIPTION OF THE DRAWINGS

The above and other features, advantages, and aspects of various embodiments of the present disclosure will become more apparent from the following detailed description with reference to the accompanying drawings. In the drawings, the same or similar reference numerals denote the same or similar elements, wherein:

FIG. 1 illustrates a schematic diagram of an example environment.

FIG. 2 illustrates a schematic diagram of one example of registering an application at a device with a digital assistant.

FIG. 3 illustrates a schematic diagram of one example of an entity correspondence between a device and a digital assistant.

FIG. 4 illustrates an example process for task processing.

FIG. 5 illustrates a flowchart of a process for task processing.

FIG. 6 illustrates a block diagram of an apparatus for task processing.

FIG. 7 illustrates a block diagram of an example device in which one or more embodiments of the present disclosure may be implemented.

### DETAILED DESCRIPTION

It would be appreciated that, before the technical solutions disclosed in the embodiments of the present disclosure are used, users should be informed of the type, the scope of use, the use scenario, etc. of the personal information involved in the present disclosure in an appropriate manner and provide authorization in accordance with relevant laws and regulations.

For example, in response to an active request being received from a user, a prompt message is sent to the user to explicitly prompt the user that an operation requested by the user would need acquisition and use of personal information of the user. As such, users may choose whether to provide personal information to the software or hardware, such as an electronic device, application, server or storage medium, that performs the operations of the technical solution of the present disclosure.

As an optional but non-limiting implementation, in response to the active request being received from the user, the prompt information may be sent to the user via, for example, a pop-up window in which the prompt information may be presented in text. In addition, the pop-up window may also contain selection controls configured for the user to choose “agree” or “disagree” to provide the personal information to the electronic device.

It would be appreciated that the above process of notification and acquisition of user authorization is merely exemplary and does not limit the implementations of the present disclosure. Other methods that meet relevant laws and regulations may also be applied to the implementation of the present disclosure.

It would be appreciated that the data involved in the technical solution (including but not limited to the data itself, data acquisition or use) should comply with the requirements of the corresponding laws, regulations and relevant provisions.

The embodiments of the present disclosure will be described in more detail below with reference to the accompanying drawings. Although certain embodiments of the present disclosure are shown in the drawings, it would be appreciated that the present disclosure can be implemented in various forms and should not be interpreted as limited to the embodiments described in this specification. On the contrary, these embodiments are provided for a more thorough and complete understanding of the present disclosure. It would be appreciated that the accompanying drawings and embodiments of the present disclosure are only for the purpose of illustration and are not intended to limit the scope of protection of the present disclosure.

It should be noted that the headline of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

Unless expressly stated herein, performing a step “in response to A” does not mean that the step is performed immediately after “A”, but may include one or more intermediate steps.

In the description of the embodiments of the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The terms “first”, “second”, etc. may refer to different or identical objects. Other explicit and implicit definitions may also be included below.

As used in this specification, the term “model” can describe an object or program that learns a correlation between respective inputs and outputs from training data, so that a corresponding output can be generated for a given input after training is completed. The generation of the model can be based on machine learning techniques. Deep learning is a machine learning algorithm that processes inputs and provides corresponding outputs by using multiple layers of processing units. As used in this specification, “model” may also be referred to as “machine learning model”, “machine learning network”, or “network”, and these terms can be used interchangeably herein. One model may comprise various processing units or networks.

Digital assistants can serve as effective tools for people's work, study and life. Generally, development of digital assistants is similar to development of general applications, requiring developers having programming skills to define the various capabilities of digital assistants by writing complex code, and deploying digital assistants on appropriate operation platforms, so that users can download, install and use the digital assistants. With the diversification of application scenarios and the availability of machine learning technologies increasing, digital assistants with different capabilities have been developed to support task processing in various subdivided fields or to meet personalized requirements of different users.

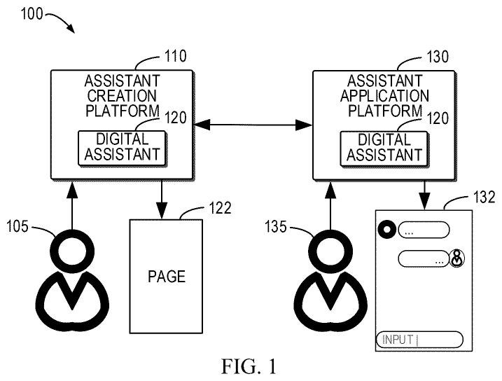

FIG. 1 illustrates a schematic diagram of an example environment 100 in which embodiments of the present disclosure can be implemented. The environment 100 relates to an assistant creation platform 110 and an assistant application platform 130.

As shown in FIG. 1, the assistant creation platform 110 can provide a user 105 with an environment for creating and releasing a digital assistant. In some embodiments, the assistant creation platform 110 may be a low-code platform that provides a collection of tools for the digital assistant creation. The assistant creation platform 110 may support visual development of the digital assistant, thereby allowing developers to skip the manual coding process, accelerate the development cycle, and reduce the cost of applications. The assistant creation platform 110 may support any suitable platform for users to develop digital assistants and other types of applications, for example, it can include platforms based on application platform-as-a-service (aPaaS). Such a platform can support users to efficiently develop applications, achieve application creation, application function adjustment, and other operations.

The assistant creation platform 110 may be deployed locally on a terminal device of the user 105 and/or may be supported by a remote server. For example, the terminal device of the user 105 may run a client of the assistant creation platform 110, and the client may support the user's interaction with the assistant creation platform 110. In the case where the assistant creation platform 110 runs locally on the terminal device of the user, the user 105 may directly utilize the client to interact with the local assistant creation platform 110. In a case that the assistant creation platform 110 runs on a server-side device, the server-side device may implement provision of services to the client running on the terminal device based on a communication connection between the assistant creation platform 110 and the terminal device. The assistant creation platform 110 may present to the user 105 a corresponding page 122 based on an operation of the user 105 so as to output information to the user 105/or receive information from the user 105.

In some embodiments, the assistant creation platform 110 may be associated with a corresponding database, which stores data or information required for the digital assistant creation process supported by the assistant creation platform 110. For example, the database may store codes and descriptive information corresponding to various function modules that make up the digital assistant. The assistant creation platform 110 may also perform operations on the functional modules in the database, such as invoking, adding, deleting, updating, and the like. The database may also store operations that can be performed on different functional blocks. For example, in a scenario in which a digital assistant is to be created, the assistant creation platform 110 may invoke a corresponding function block from the database to build the digital assistant.

In embodiments of the present disclosure, the user 105 may create a digital assistant 120 on the assistant creation platform 110 and release the digital assistant 120 as needed. The digital assistant 120 may be released to any suitable assistant application platform 130, as long as the assistant application platform 130 can support the execution of the digital assistant 120. After the digital assistant 120 is released, it may be used for conversational interaction with a user 135. The client of the assistant application platform 130 may present an interaction window 132 of the digital assistant 120 in the client interface, such as the conversation window. The digital assistant 120, as an intelligent assistant, has intelligent conversation and information processing capabilities. The user 135 may enter a conversation message in the conversation window, and the digital assistant 120 may determine a reply message based on created configuration information and present it to the user in the interaction window 132. In some embodiments, depending on the configuration of the digital assistant 120, the interaction message with the digital assistant 120 may comprise messages in various multimodal message formats such as text messages (e.g., natural language text), voice messages, image messages, video messages, and so on.

In some embodiments, the digital assistant 120 may utilize a model to assist in performing interactions with the user. The model used by the digital assistant 120 may run locally at the assistant creation platform 110 and/or the assistant application platform 130, or at a remote server. In some embodiments, the model may be a machine learning model, a deep learning model, a learning model, a neural network, etc. In some embodiments, the model may be based on a language model (LM). The language model can have question-answering capability by learning from a large corpus of data. The model may also be based on any other suitable model.

Here, the user 105 creating the digital assistant is sometimes referred to as an assistant creator, assistant developer, or the like. The user 135 interacting with the created digital assistant is also sometimes referred to as a user, customer, etc. of the digital assistant.

The assistant creation platform 110 and/or the assistant application platform 130 may run on an appropriate electronic device, where the electronic device may be any suitable type of device having computing capabilities, including a terminal device or a server device. The terminal device may be any type of mobile terminal, fixed terminal, or portable terminal including a mobile handset, desktop computer, laptop computer, notebook computer, netbook computer, tablet computer, media computer, multimedia tablet, personal communication system (PCS) device, personal navigation device, personal digital assistant (PDA), audio/video player, digital camera/camcorder, positioning device, television receiver, radio broadcast receiver, electronic book device, game device, or any combination of the foregoing, including accessories and peripherals for these devices, or any combination thereof. A server device may, for example, comprise a computing system/server, such as a mainframe, an edge computing node, a computing device in a cloud environment, etc. In some embodiments, the assistant creation platform 110 and/or the assistant application platform 130 may be implemented based on a cloud service.

The embodiments of the present disclosure involve an application phase after the digital assistant is created, thus the embodiments may be implemented at the assistant application platform, for example, a terminal device installed with the assistant application platform and/or a server corresponding to the assistant application platform. In the examples below, for the purpose of discussion, descriptions are made from the perspective of the assistant application platform, such as the assistant application platform 130 shown in FIG. 1. The page presented by the assistant application platform 130 may be presented via the terminal device of the user 135, and user input may be received via the terminal device of the user 135.

It would be appreciated that the structure and functionality of the environment 100 are described for the purposes of illustration only and are not intended to imply any limitation on the scope of the disclosure. For example, although FIG. 1 illustrates a single user interacting with the assistant creation platform 110 and a single user interacting with the assistant application platform 130, but multiple users can actually access the assistant creation platform 110 to create a digital assistant respectively, and each digital assistant can be used to interact with multiple users.

Generally, in the process of the interaction between users and digital assistants, the digital assistants may parse user inputs to determine the tasks indicated by the users. In some cases, the processing of such tasks may need to use an application installed on a terminal device used by the user. However, such digital assistants may not be native to the terminal device. Accordingly, there is a need for digital assistants to use such applications reasonably and efficiently.

According to embodiments of the present disclosure, an improved solution for interacting with digital assistants is provided. According to the solution, a digital assistant running on a target device interacts with a user. A target task to be executed at the target device is determined during the interaction process. If the target task is associated with a target application on the target device, availability of the target application is determined. The availability indicates whether the digital assistant is permitted to execute the target task using the target application. Feedback information for the target task is determined based on the availability. For example, the digital assistant may present prompt information to the user or execute the target task according to guidance information.

Thus, during the interaction process between the user and the digital assistant, an application local to the terminal device may be appropriately invoked to complete a task instructed by the user. In this way, from the perspective of the user, the digital assistant can fully utilize the local applications to provide various suitable assistance, such that good interaction experience can be obtained. This improves the efficiency of the digital assistant in assisting the user.

Some example embodiments of the present disclosure will be described in detail below with reference to examples of the accompanying drawings.

After being created, the digital assistant 120 may be installed and run on the terminal device of the user 135. In some embodiments, to enable the digital assistant 120 to know and reasonably utilize applications at the terminal device, the applications at the terminal device may be registered with the digital assistant 120. As used in this specification, the phrasing such as the applications at the terminal device being registered with the digital assistant, registering the applications with the digital assistant, or the like, may refer to providing or exposing information associated with the application to the digital assistant and authorizing the digital assistant to use at least a portion of the application.

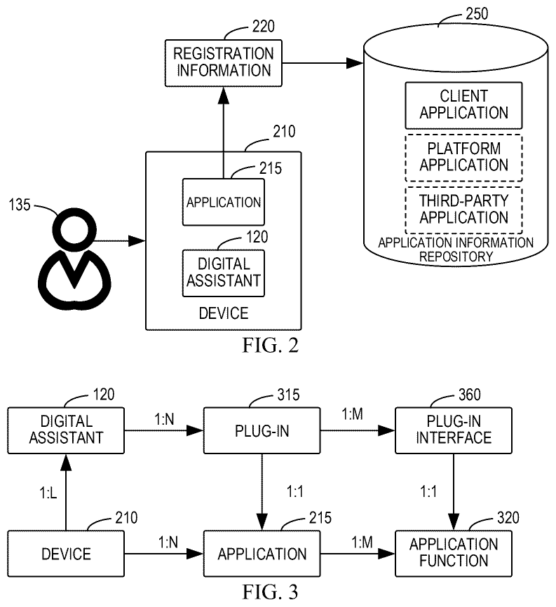

An example of registering an application with the digital assistant 120 is described below with reference to FIG. 2. As shown in FIG. 2, the digital assistant 120 is deployed and running on a device 210. An application 215 is installed in the device 210. In some embodiments, registration of the application 215 with the digital assistant may be triggered if a predetermined event at the device 210 is detected. Accordingly, registration information 220 of the application 210 may be stored to an application information repository 250. The registration information 220 may include, but is not limited to, version information, a functional description of the application 215, a scope to which the digital assistant 120 is permitted access, and the like.

The predetermined event may include, for example and without limitation, the installation and update of the application 215, a first run and update of the digital assistant 120 on the device 210, a restart of the device 210, and the like. Exemplarily, the digital assistant 120 may acquire registration information 220 of the application 215, and store the registration information 220 into the application information repository 250.

The acquisition and storage of the registration information 220 is performed by the digital assistant 120 with permission and authorization of the user 136. For example, the digital assistant 120 may present inquiry information to the user 135 in any suitable form to request the user 135 to confirm whether to register the application 215 with the digital assistant 120 and to permit a scope for access by the digital assistant 120, etc. If a positive answer of the user 135 is obtained, the digital assistant 120 obtains the registration information 220 and stores it to the application information repository 250.

In some embodiments, applications registered to the digital assistant 120 may be included as candidate applications in a set of candidate applications. The application information repository 250 may be maintained by a server and/or a client of the assistant application platform 130, and may be used to store information of each candidate application in the candidate application set. The application 215 on the device 210, for example, may be registered as a client application suitable for invocation by the digital assistant 120.

In some embodiments, in addition to the client application, other types of applications suitable for digital assistant invocation may be included in the candidate application set, such as, but not limited to, platform applications provided by the assistant application platform 130, third-party applications provided by a third-party (e. g., application developers), and so on. The embodiments of the present disclosure are not limited in this regard. Accordingly, as shown in FIG. 2, information of a platform application and information of a third-party application may be stored in the application information repository 250.

In some embodiments, the application 215 may include multiple functions (also referred to as application functions), all or a portion of which may be registered with the digital assistant 120. The digital assistant 120 may ask the user 135 which function or functions is/are to be registered with the digital assistant (e. g., in a natural language interaction). For example, an application for content sharing may include a playback function of media content and a posting function of media content. The user 135 may choose to register the playback function with the digital assistant 120 without registering the posting function. In such embodiments, the registration information 220 may include information of one or more functions to be registered with the digital assistant 120, such as an invocation interface, etc.

The registered application may be invoked by the digital assistant 120 in any suitable manner. By way of example and without limitation, the registered application may be embodied as or correspond to a plug-in suitable for invocation by the digital assistant 120. For example, a developer of an application may define a functional description, which may be exposed to the digital assistant 120, in the form of a plug-in to a service end of the assistant application platform 130. Accordingly, the digital assistant 120 may report available functions to the service end.

For the purpose of a clear understanding of the embodiments of the present disclosure only, a correspondence between a plurality of entities is described with reference to FIG. 3. As shown in FIG. 3, there may be L digital assistants 120 at the single device 210, wherein L is a positive integer. Meanwhile, N applications 215 may be installed or authorized at the single device 210 for use by the digital assistant 120, wherein N is a positive integer. Then the single application 215 may have M application functions 320, wherein M is a positive integer. For the digital assistant 120, one application 215 corresponds to one plug-in 315, and one application function 320 corresponds to one plug-in interface 360 that can be invoked. It would be appreciated that the entity correspondence described above with reference to FIG. 3 is merely exemplary and is not intended to be limiting.

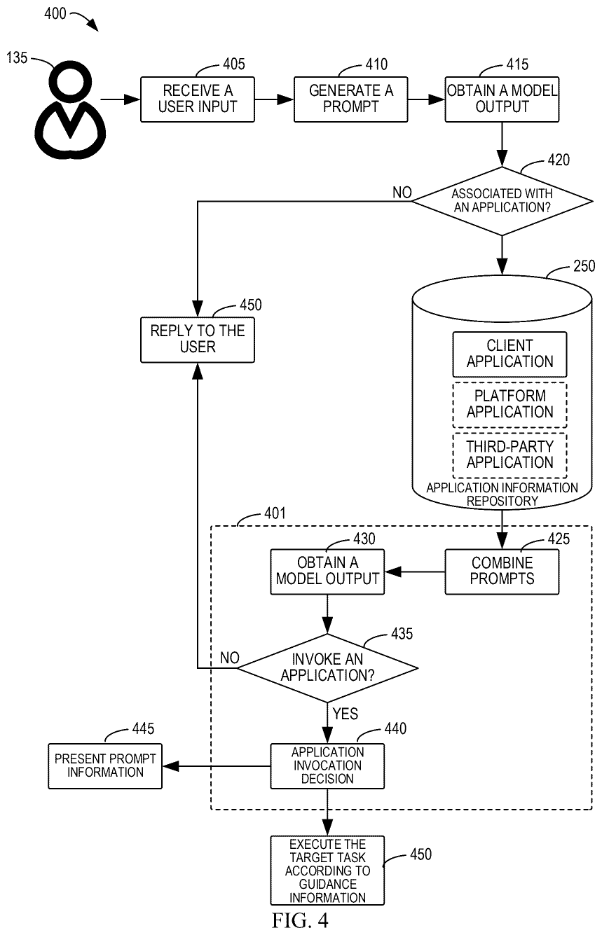

FIG. 4 illustrates an example process 400 for task processing in accordance with some embodiments of the disclosure. For ease of discussion, the process 400 will be described with reference to the environment of FIG. 1. The process 400 involves an application phase of the digital assistant 120 after creation, and thus may be implemented at the assistant application platform 130. It should be understood that the operations described in the following with respect to the assistant application platform 130 and/or the digital assistant 120 may be specifically performed by a terminal device and/or a server running the assistant application platform 130 and/or the digital assistant 120, or may be appreciated as being executed by using an application program corresponding to the assistant application platform 130 and/or the digital assistant 120.

In the embodiments of the present disclosure, the assistant application platform 130 may determine a target task to be executed at a target device based on an interaction between the user 135 and the digital assistant 120. The digital assistant 120 runs on the target device. The interaction between the user 135 and the digital assistant 120 may be performed in a natural language format, or at least comprise an interaction in a natural language format. In some embodiments, the target device may be a device at which the user 135 is currently interacting with the digital assistant 120. In some embodiments, the target device may be another device running the digital assistant 120 and associated with the user 135. For example, the digital assistant 120 may run on multiple terminal devices of the user 135, and the user 135 may interact with the digital assistant 120 through one of the terminal devices to instruct the digital assistant 120 to execute a task on another terminal device.

In some embodiments, the digital assistant 120 may utilize a machine learning model to determine a target task based on interactions. For example, a prompt for the machine learning model may be generated based on one or more interaction messages of the user 135 in the interaction. Accordingly, the machine learning model may generate a model output based on the prompt. The digital assistant 120 may determine a target task based on the model output.

In some embodiments, the target task may be determined based on multiple rounds of interactions between the user 135 and the digital assistant 120. The type of the task to be executed may be determined based on a first user input from the user. Based on the type, a response of the digital assistant 120 is generated for the first user input. The response indicates that the user 135 provides additional information about the task to be executed. A second user input for the response may then be received, and a target task may be determined based on the first user input and the second user input.

As mentioned above, in some embodiments, the machine learning model may be utilized to determine the target task. For example, first and second prompts may be generated based on the first and second user inputs, respectively, and the combined first and second prompts may be provided to the machine learning model. Then the target task may be determined based on a model output of the machine learning model for the combined first and second prompts.

An example process 400 is described with reference to FIG. 4. The process 400 may be executed by a terminal device and/or a server of the assistant application platform 130 and/or the digital assistant 120. The subject that performs the actions or operations described below is merely an example and is not intended to be limiting. As shown in FIG. 4, at block 405, the digital assistant 120 may receive a user input, e.g., via a client. At block 410, the assistant application platform 130 may generate a prompt for a machine learning model based on the user input. The prompt may be generated in any suitable manner, and the embodiments of the present disclosure is not limited in this regard. The prompt is then provided to the machine learning model which may run on the assistant application platform 130 or may be accessed by the assistant application platform 130 in any suitable manner.

At block 415, the assistant application platform 130 may obtain a model output of the machine learning model. Based on the model output, the type of task to be executed may be determined. For example, the user input may be “I want to send a short message to xx.” Accordingly, the model output of the machine learning model may indicate that the type of task to be executed is to send a short message.

At block 420, whether the task to be executed is associated with an application may be determined. For example, whether execution of the task needs to invoke an application may be determined. If the task to be executed is not associated with an application, the process 400 proceeds to block 450. At block 450, a reply may be provided to the user 135. For example, a message template for reply may be determined. The message template may be filled in based on the user input received at block 405 and/or the output of the machine learning model, and presented to user 135, e.g., via the client.

If the task to be executed is associated with an application, the assistant application platform 130 may select an application from a set of candidate applications that is suitable for executing the task. In the example of FIG. 4, the assistant application platform 130 can access the application information repository 250 to inquire whether there is any suitable application. For example, a determination is made of whether there is an application suitable for executing this type of task. If a suitable application is present, the process 400 continues. As mentioned above, in some cases, a single input of the user may be not able to completely indicate a target task. In this case, the digital assistant 120 may enable a chain process, such as shown in block 401, to make the decision.

For example, the assistant application platform 130 may generate a response of the digital assistant to the last user input and the response may instruct the user 135 to provide additional information about the task to be executed. Continuing with the above example, the response message may instruct the user 135 to provide specific content for the short message to be sent. The assistant application platform 130 may then receive an additional user input. An additional prompt may be determined based on the additional user input. The previous and additional prompts may be combined at block 425. The combined prompts may then be provided to the machine learning model. At block 430, a model output of the machine learning model may be obtained, and a target task may be determined based on the model output.

Continuing with the above example, the additional user input may include the content “meeting time has been determined” of the short message. Accordingly, based on the previous user input and the additional user input, the target task may be determined to be “send a short message to xx with the content of ‘meeting time has been determined.’”

At block 435, the assistant application platform 130 may determine whether to invoke one or more applications. If it is determined that no application is to be invoked, the flow 400 proceeds to block 450. At block 450, a reply may be provided to the user 135. For example, a message template for reply may be determined. The message template may be filled in according to a number of rounds of user inputs and/or outputs of the machine learning model, and presented to the user 135, e.g., via a client.

If it is determined to invoke an application, the process 400 proceeds to block 440. At block 440, an application invocation decision may be executed. In particular, it may be determined whether the target task to be executed would invoke an application, also referred to as a target application, on the target device. If it is determined that the target application is to be invoked, availability of the target application may be determined, i.e., it may be determined whether the digital assistant 120 is permitted to execute the target task using the target application.

In some embodiments, whether the target device has registered the target application with the digital assistant 120 may be determined. If the target device has registered the target application with the digital assistant 120, the availability may be determined based on the registration information of the target application. For example, if the registration information for the target application can be found in the application information repository 250, it may be determined that the target application has been registered with the digital assistant 120. Further, the availability may be determined based on the registration information. In some embodiments, the availability may be application-based, that is, as long as the registration information of the target application can be found, it can be determined that the digital assistant 120 is permitted to execute the target task by using the target application.

In some embodiments, the availability may be application function-based. As mentioned above, if the target application includes multiple application functions, some of these functions may be registered with the digital assistant 120 and some others may not. In such embodiments, the availability may be further determined based on the function required for executing the target task.

For example, a target function for executing the target task may be determined from a plurality of functions of the target application. If the registration information for the target application indicates that the target function is registered, it may be determined that the digital assistant 120 is permitted to execute the target task using the target application. If the registration information for the target application indicates that the target function is not registered, it may be determined that the digital assistant is not permitted to execute the target task using the target application. Continuing with the above example, the message application on the target device may include a short message viewing function and a short message sending function. For the target task of “send a short message to xx with content of ‘meeting time has determined’”, if the viewing function is registered with the digital assistant 120 while the sending function is not registered, then the target application may be determined as unavailable, i.e., the digital assistant 120 is not permitted to utilize the target application to execute the target task. If the sending function is registered with the digital assistant 120, it may be determined that the target application is available, i.e., the digital assistant 120 is permitted to execute the target task using the target application.

Continuing with the process 400. If it is determined that the digital assistant 120 is not available, the assistant application platform 130 may generate prompt information that instructs the user to enable the target application for the digital assistant 120. Then the prompt information may be presented via the client at block 445. For example, a prompt message “please enable the short message sending function for the digital assistant” may be presented in a conversation window for the user.

If it is determined that the digital assistant 120 is available, the assistant application platform 130 may determine guidance information for executing the target task. The guidance information may include, for example, various configurations required for executing the target task, such as an identification of the application (or function thereof) to be invoked, or a parameter to fill in the application interface. Continuing with the above example, the guidance information may include an identification of the sending function of the short message, a parameter of the object “xx” to whom the short message is to be sent, a content to be sent, and the like. The digital assistant 120 may then execute the target task according to the guidance information at block 450.

Through such multiple rounds of interaction, the task indicated by the user can be precisely located and executed to assist the user. Thus, the efficiency of assistance to the user can be improved.

In order to provide a clear understanding of the embodiments of the present disclosure, an example scenario will be described below for illustration only and without limitation. The user 135 may use a terminal device installed with a content sharing application, which includes a playback function of media content and a posting function of media content. Upon the content sharing application being installed or first launched, the digital assistant 120 prompts the user 135 whether to register the content sharing application with the digital assistant 120. The user 135 may choose to register the playback function without registering the posting function. In an example, in the subsequent use of the digital assistant 120, the assistant application platform 130 determines that a target task is to playback video A based on multiple rounds of interaction with the user 135. Since the playback function of media content is registered to the digital assistant 120, it may be determined that the content sharing application is available. Accordingly, guidance information may be generated for playing video A at the terminal device of user 135.

In another example, in the subsequent use of the digital assistant 120, the assistant application platform 130 determines, through multiple rounds of interactions with the user 135, that the target task is to post video B that is stored locally in the terminal device by using the content sharing application. Since the posting function of media content is not registered with the digital assistant 120, it may be determined that the content sharing application is unavailable. Accordingly, prompt information may be generated and presented to the user 135 via the terminal device. For example, the prompt information may prompt the user 135 to enable the posting function for the digital assistant.

### Example Processes

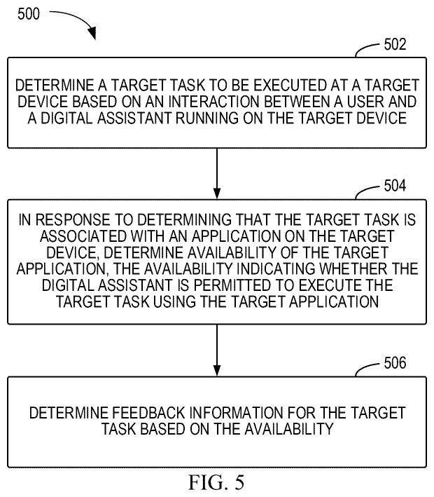

FIG. 5 illustrates a flowchart of a process 500 for task processing according to some embodiments of the disclosure. The process 500 may be implemented at the assistant application platform 130, for example, may be executed by a terminal device and/or a server of the assistant application platform 130 and/or the digital assistant 120. The process 500 is described below with reference to FIG. 1.

At block 502, based on an interaction between a user and a digital assistant, a target task to be executed at a target device is determined. The digital assistant runs on the target device.

At block 504, in response to determining that the target task is associated with a target application on the target device, the availability of the target application is determined. The availability of the target application indicates whether the digital assistant is permitted to execute the target task using the target application.

At block 506, feedback information for the target task is determined based on the availability of the target application.

In some embodiments, determining the target task to be executed at the target device comprises: determining a type of task to be executed based on a first user input from the user; generating a response of the digital assistant to the first user input according to the type, the response instructing the user to provide additional information about the task to be executed; receiving a second user input for the response; and determining the target task based on the first user input and the second user input.

In some embodiments, determining the target task based on the first user input and the second user input comprises: generating a first prompt and a second prompt based on the first user input and the second user input, respectively; providing a combination of the first prompt and the second prompt to a machine learning model; and determining the target task based on a model output of the machine learning model for the first prompt and second prompt.

In some embodiments, determining the availability of the target application comprises: determining whether the target device has registered the target application with the digital assistant; and in response to determining that the target device has registered the target application with the digital assistant, determining the availability based on registration information for the target application.

In some embodiments, the target application includes a plurality of functions. The registration information indicates which functions of the plurality of functions is registered with the digital assistant and determining the availability based on the registration information for the target application comprises: determining a target function for executing the target task from the plurality of functions; in response to the registration information indicating that the target function is registered, determining that the digital assistant is permitted to execute the target task using the target application, or in response to the registration information indicating that the target function is not registered, determining that the digital assistant is not permitted to execute the target task using the target application.

In some embodiments, the method 500 further comprises triggering registration of the target application with the digital assistant in response to a predetermined event at the target device.

In some embodiments, determining the feedback information about the target task comprises generating prompt information in response to determining that the digital assistant is not permitted to execute the target task using the target application. The prompt information instructs the user to enable the target application for the digital assistant.

In some embodiments, determining the feedback information for the target task comprises: in response to determining that the digital assistant is permitted to execute the target task using the target application, determining guidance information for executing the target task based on the interaction.

In some embodiments, the target application is selected from a set of candidate applications.

### Example Apparatus and Device

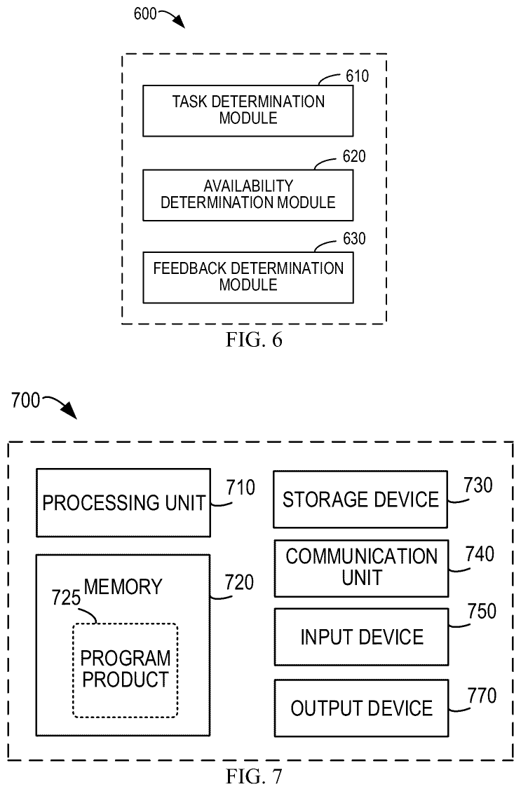

FIG. 6 shows a schematic structural block diagram of an apparatus 600 for task processing according to certain embodiments of the present disclosure. The apparatus 600 may be implemented as or included in the assistant application platform 130. The various modules/components in the apparatus 600 may be implemented by hardware, software, firmware, or any combination thereof.

As shown in the figure, the apparatus 600 includes a task determination module 610, an availability determination module 620, and a feedback determination module 630. The task determination module 610 is configured to determine a target task to be executed at a target device based on an interaction between a user and a digital assistant. The digital assistant runs on the target device. The availability determination module 620 is configured to determine the availability of the target application in response to determining that the target task is associated with a target application on the target device. The availability indicates whether the digital assistant is permitted to execute the target task using the target application. The feedback determination module 630 is configured to determine feedback information for the target task based on the availability of the target application.

In some embodiments, the task determination module 610 includes a type determination module, a generation module, a receiving module, and a first target task determination module. The type determination module is configured to determine, based on a first user input from the user, a type of task to be executed. The generation module is configured to generate a response of the digital assistant to the first user input according to the type, the response instructing the user to provide additional information about the task to be executed. The receiving module is configured to receive a second user input for the response. The first target task determination module is configured to determine the target task based on the first user input and the second user input.

In some embodiments, the first target task determination module includes a prompt generation module, a provision module, and a second target task determination module. The prompt generation module is configured to generate a first prompt and a second prompt based on the first user input and the second user input, respectively. The provision module is configured to provide a combination of the first and the second prompt to a machine learning model. The second target task determination module is configured to determine a target task based on a model output of the machine learning model for the first prompt and the second prompt.

In some embodiments, the availability determination module 620 includes a target application determination module, and an application availability determination module. The target application determination module is configured to determine whether the target device has registered the target application with the digital assistant. The application availability determination module is configured to, in response to determining that the target device has registered the target application with the digital assistant, determine the availability based on registration information of the target application.

In some embodiments, the target application includes a plurality of functions, and the registration information indicates one or more functions of the plurality of functions that are registered to the digital assistant. The application availability determination module includes a target function determination module, a first determination module, and a second determination module. The target function determination module is configured to determine, from the plurality of functions, a target function for executing the target task. The first determination module is configured to, in response to the registration information indicating that the target function is registered, determining that the digital assistant is permitted to execute the target task using the target application. The second determination module is configured to, in response to the registration information indicating that the target function is not registered, determining that the digital assistant is not permitted to execute the target task using the target application.

In some embodiments, the apparatus 600 further comprises a trigger module configured to trigger registration of the target application with the digital assistant in response to a predetermined event at the target device.

In some embodiments, the feedback determination module 630 includes a prompt generation module configured to generate prompt information in response to determining that the digital assistant is not permitted to execute the target task using the target application. The prompt information instructs the user to enable the target application for the digital assistant.

In some embodiments, the feedback determination module 630 includes a guidance information determination module configured to, in response to determining that the digital assistant is permitted to execute a target task using the target application, determining guidance information for executing the target task based on the interaction.

In some embodiments, the target application is selected from a set of candidate applications.

FIG. 7 illustrates a block diagram of an example electronic device 700 in which one or more embodiments of the present disclosure may be implemented. It would be appreciated that the electronic device 700 illustrated in FIG. 7 is merely exemplary and should not constitute any limitation on the functionality and scope of the embodiments described herein. The electronic device 700 shown in FIG. 7 may be configured to implement the assistant creation platform 110 and/or the assistant application platform 130 of FIG. 1, and/or the apparatus 600 of FIG. 6.

As shown in FIG. 7, the electronic device 700 is in the form of a general-purpose electronic device. Components of the electronic device 700 may include, but are not limited to, one or more processors or processing units 710, a memory 720, a storage device 730, one or more communication units 740, one or more input devices 750, and one or more output devices 760. The processing unit 710 may be an actual or virtual processor capable of executing various processes according to a program stored in the memory 720. In a multiprocessor system, a plurality of processing units execute computer-executable instructions in parallel to improve the parallel processing capability of the electronic device 700.

The electronic device 700 typically includes a number of computer storage media. Such media may be any available media that is accessible to electronic device 700, including, but not limited to, volatile and non-volatile media, removable and non-removable media. The memory 720 may be volatile memory (e. g., registers, cache, random access memory (RAM)), non-volatile memory (e. g., read-only memory (ROM), electrically-erasable programmable read-only memory (EEPROM), flash memory), or some combination thereof. The storage device 730 may be a removable or non-removable medium and may include a machine-readable medium such as a flash drive, a magnetic disk, or any other medium that may be used to store information and/or data and that may be accessed within the electronic device 700.

The electronic device 700 may further comprise additional removable/non-removable, volatile/nonvolatile storage media. Although not shown in FIG. 7, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 720 may include a computer program product 725 having one or more program modules configured to execute various methods or actions of various embodiments of the present disclosure.

The communication unit 740 enables communication with other electronic devices over a communication medium. Additionally, the functionality of the components of the electronic device 700 may be implemented in a single computing cluster or in multiple computing machines that are capable of communicating over a communication connection. Thus, the electronic device 700 may run in a networked environment using logical connections to one or more other servers, network personal computers (PCs), or another network node.

The input device(s) 750 may be one or more input devices such as a mouse, keyboard, trackball, etc. The output device(s) 760 may be one or more output devices such as a display, speakers, printer, etc. The electronic device 700 may also communicate with one or more external devices (not shown), such as storage devices, display devices, etc., as needed through the communication unit 740, with one or more devices that enable a user to interact with the electronic device 700, or with any device (e. g., network card, modem, etc.) that enables the electronic device 700 to communicate with one or more other electronic devices. Such communication may be executed via an input/output (I/O) interface (not shown).

According to example implementations of the present disclosure, a computer-readable storage medium having computer-executable instructions stored thereon is provided. The computer-executable instructions are executed by a processor to implement the method described above. According to example implementations of the present disclosure, a computer program product is further provided. The computer program product is tangibly stored on a non-transitory computer-readable medium and includes computer-executable instructions. The computer-executable instructions are executed by a processor to implement the method described above.

Various aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations of the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations of the present disclosure have been described above. The above description is exemplary, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

1. A method for task processing, comprising:
determining a target task to be executed at a target device based on an interaction between a user and a digital assistant, wherein the digital assistant runs on the target device;
in response to determining that the target task is associated with a target application on the target device, determining availability of the target application, the availability of the target application indicating whether the digital assistant is permitted to execute the target task using the target application; and
determining feedback information for the target task based on the determined availability of the target application.

2. The method of claim 1, wherein determining the target task to be executed at the target device comprises:
determining a type of task to be executed based on a first user input from the user;
generating, according to the type, a response of the digital assistant to the first user input, the response instructing the user to provide additional information about the task to be executed;
receiving a second user input for the response; and
determining the target task based on the first user input and the second user input.

3. The method of claim 2, wherein determining the target task based on the first user input and the second user input comprises:
generating a first prompt and a second prompt based on the first user input and the second user input, respectively;
providing a combination of the first prompt and the second prompt to a machine learning model; and
determining the target task based on a model output of the machine learning model for the first prompt and the second prompt.

4. The method of claim 1, wherein determining the availability of the target application comprises:
determining whether the target device has registered the target application with the digital assistant; and
in response to determining that the target device has registered the target application with the digital assistant, determining the availability based on registration information of the target application.

5. The method of claim 4, wherein the target application comprises a plurality of functions, the registration information indicates one or more functions of the plurality of functions that are registered to the digital assistant, and determining the availability based on the registration information for the target application comprises:
determining, from the plurality of functions, a target function for executing the target task; and
in response to the registration information indicating that the target function is registered, determining that the digital assistant is permitted to execute the target task using the target application, or
in response to the registration information indicating that the target function is not registered, determining that the digital assistant is not permitted to execute the target task using the target application.

6. The method of claim 4, further comprising:
triggering registration of the target application with the digital assistant in response to a predetermined event at the target device.

7. The method of claim 1, wherein determining the feedback information for the target task comprises:
in response to determining that the digital assistant is not permitted to execute the target task using the target application, generating prompt information that instructs the user to enable the target application for the digital assistant.

8. The method of claim 1, wherein determining the feedback information for the target task comprises:
in response to determining that the digital assistant is permitted to execute the target task using the target application, determining guidance information for executing the target task based on the interaction.

9. The method of claim 1, wherein the target application is selected from a set of candidate applications.

10. An electronic device, comprising:
at least one processing unit; and
at least one memory coupled to the at least one processing unit and storing instructions for execution by the at least one processing unit that, the instructions, when executed by the at least one processing unit, causing the electronic device to perform operations comprising:
determining a target task to be executed at a target device based on an interaction between a user and a digital assistant, wherein the digital assistant runs on the target device;
in response to determining that the target task is associated with a target application on the target device, determining availability of the target application, the availability of the target application indicating whether the digital assistant is permitted to execute the target task using the target application; and
determining feedback information for the target task based on the determined availability of the target application.

11. The electronic device of claim 10, wherein determining the target task to be executed at the target device comprises:
determining a type of task to be executed based on a first user input from the user;
generating, according to the type, a response of the digital assistant to the first user input, the response instructing the user to provide additional information about the task to be executed;
receiving a second user input for the response; and
determining the target task based on the first user input and the second user input.

12. The electronic device of claim 11, wherein determining the target task based on the first user input and the second user input comprises:
generating a first prompt and a second prompt based on the first user input and the second user input, respectively;
providing a combination of the first prompt and the second prompt to a machine learning model; and
determining the target task based on a model output of the machine learning model for the first prompt and the second prompt.

13. The electronic device of claim 10, wherein determining the availability of the target application comprises:
determining whether the target device has registered the target application with the digital assistant; and
in response to determining that the target device has registered the target application with the digital assistant, determining the availability based on registration information of the target application.

14. The electronic device of claim 13, wherein the target application comprises a plurality of functions, the registration information indicates one or more functions of the plurality of functions that are registered to the digital assistant, and determining the availability based on the registration information for the target application comprises:
determining, from the plurality of functions, a target function for executing the target task; and
in response to the registration information indicating that the target function is registered, determining that the digital assistant is permitted to execute the target task using the target application, or
in response to the registration information indicating that the target function is not registered, determining that the digital assistant is not permitted to execute the target task using the target application.

15. The electronic device of claim 13, wherein the operations further comprise:
triggering registration of the target application with the digital assistant in response to a predetermined event at the target device.

16. The electronic device of claim 10, wherein determining the feedback information for the target task comprises:
in response to determining that the digital assistant is not permitted to execute the target task using the target application, generating prompt information that instructs the user to enable the target application for the digital assistant.

17. The electronic device of claim 10, wherein determining the feedback information for the target task comprises:
in response to determining that the digital assistant is permitted to execute the target task using the target application, determining guidance information for executing the target task based on the interaction.

18. The electronic device of claim 10, wherein the target application is selected from a set of candidate applications.

19. A non-transitory computer readable storage medium, having a computer program stored thereon, wherein the computer program is executable by a processor to perform operation comprising:
determining a target task to be executed at a target device based on an interaction between a user and a digital assistant, wherein the digital assistant runs on the target device;
in response to determining that the target task is associated with a target application on the target device, determining availability of the target application, the availability of the target application indicating whether the digital assistant is permitted to execute the target task using the target application; and
determining feedback information for the target task based on the determined availability of the target application.

20. The computer readable storage medium of claim 19, wherein determining the target task to be executed at the target device comprises:
determining a type of task to be executed based on a first user input from the user;
generating, according to the type, a response of the digital assistant to the first user input, the response instructing the user to provide additional information about the task to be executed;
receiving a second user input for the response; and
determining the target task based on the first user input and the second user input.
